(19) United States
(12) Patent Application Publication
(10) Pub. No.: US 2026/0012300 A1
(43) Pub. Date: Jan. 8, 2026

(54) POLAR CODED BIT TRANSMISSION VIA NONIDENTICAL ORTHOGONAL FREQUENCY DIVISION MULTIPLEXING

(71) Applicant: Wichita State University, Wichita, KS (US)

(72) Inventors: Hyuck M. Kwon, Wichita, KS (US); Walter L. Roensch, JR., Wichita, KS (US)

(21) Appl. No.: 19/263,052

(22) Filed: Jul. 8, 2025

Related U.S. Application Data
(60) Provisional application No. 63/668,382, filed on Jul. 8, 2024.

(51) Int. Cl. H04L 5/00; H04B 17/309; H04L 1/00

(52) U.S. Cl. CPC H04L 5/0007; H04B 17/346; H04L 1/003

(57) ABSTRACT

A method of communication between devices in a cellular network includes transmitting data via orthogonal-frequency-division-multiplexing (OFDM) subcarriers, determining signal-to-interference-plus-noise-ratios (SINRs) for the subcarriers, generating a reliability sequence based on the SINRs, and permuting subsequent data transmissions based on the reliability sequence. The reliability sequence may be generated by ranking subcarriers, designating high and low reliability channels, and calculating a polarization value. The method may be implemented in a base station node or user equipment of a cellular network. The approach may improve transmission reliability by allocating data bits to subcarriers based on their measured performance characteristics.

### CROSS-REFERENCE TO RELATED APPLICATION

The present application claims priority to U.S. Provisional Patent App. No. 63/668,382 filed Jul. 8, 2024, which is hereby incorporated by reference in its entirety.

### FIELD

This disclosure pertains to wireless data transmission for future wireless communication protocols, and more specifically, to improvements in orthogonal frequency division multiplexing techniques.

### BACKGROUND

When data is transferred wirelessly, there is always some level of interference/noise. While there are obvious remedies with respect to hardware (better antennas, more power, etc.), there are less obvious remedies with respect to the data transfer process itself. “Channel coding” is a generic term for the process of encoding and decoding information in specific ways in order to reduce the prevalence of errors, which can be defined in terms of “bit error rate” (BER). High performance channel codes may mitigate bit error rate. However, channel codes must be sufficiently low complexity to be feasible within time and power constraints.

OFDM (Orthogonal Frequency Division Multiplexing) is a modulation technique used in many modern communication systems, including 5G, Wi-Fi, and LTE. It works by dividing a wideband frequency channel into multiple narrower subcarriers that are orthogonal to each other. Each subcarrier carries a portion of the overall data stream. Modern communication systems, such as 5G, Wi-Fi, and LTE, assume that all OFDM subcarrier channels have identical performance.

### SUMMARY

In one embodiment, a method of communication between a first communication device and a second communication device includes transmitting a first plurality of data via a signal comprising multiple orthogonal-frequency-division-multiplexing (OFDM) subcarriers. The method involves determining a signal-to-interference-plus-noise-ratio (SINR) for each of the OFDM subcarriers. A reliability sequence is generated using the SINRs of each of the OFDM subcarriers. The method further includes permuting a second plurality of data based on the reliability sequence and transmitting the second plurality of data from the first communication device to the second communication device.

In another embodiment, a cellular network configured for high reliability wireless data transmission includes a base station node and at least one user equipment configured to wirelessly communicate with one another. The base station node includes one or more station processors operably coupled to one or more non-transitory computer-readable media storing instructions. When executed, these instructions configure the base station node to transmit a first plurality of data via a signal comprising multiple OFDM subcarriers to the user equipment. In response to receiving SINRs associated with each of the OFDM subcarriers from the user equipment, the base station node generates a reliability sequence using the received SINRs. The base station node then permutes a second plurality of data based on the reliability sequence and transmits the permuted data to the user equipment via the OFDM subcarriers.

In another embodiment, a cellular network configured for high reliability wireless data transmission includes user equipment with one or more user equipment processors operably coupled to one or more non-transitory computer-readable media storing instructions. When executed, these instructions configure the user equipment to determine a SINR for each of multiple OFDM subcarriers transmitted by the base station node. The user equipment generates a reliability sequence using the determined SINRs of each of the OFDM subcarriers and transmits the reliability sequence to the base station node.

Other aspects and features will be apparent hereinafter.

### BRIEF DESCRIPTION OF THE DRAWINGS

FIG. 1 is a Tanner graph of a polar code having identical N=4-vector binary erasure channels.

FIG. 2 is a Tanner graph of a polar code having nonidentical N=4-vector binary erasure channels.

FIG. 3 is a graph showing polarized channel capacities for N=2 identical and nonidentical polar code channels.

FIG. 4 is a graph showing polarized channel capacities for N=4 identical polar code channels.

FIG. 5 is a graph showing polarized channel capacities for N=4 nonidentical polar code channels.

FIG. 6 is similar to FIG. 5, but the polar code channels have different erasure probabilities.

FIG. 7 is a graph showing polarized channel capacities for N=8 identical polar code channels.

FIG. 8 is a graph showing polarized channel capacities for N=8 nonidentical polar code channels.

FIG. 9 is a graph showing channel capacity of N=8 versus sorted bit channel index for identical and nonidentical polar code channels.

FIG. 10 is a graph showing polarized channel capacities for N=128 nonidentical binary erasure channels.

FIG. 11 is similar to FIG. 10, but the binary erasure channels have different erasure probabilities.

FIG. 12 is a graph showing bit error rate as a function of erasure probability for N=2 nonidentical polar code channels.

FIG. 13 is a graph showing bit error rate as a function of erasure probability for N=4 nonidentical binary erasure channels.

FIG. 14 is a graph showing bit error rate as a function of crossover probability for N=4 nonidentical binary symmetric channels.

FIG. 15 is a graph showing bit error rate as a function of erasure probability for N=128 nonidentical binary erasure channels.

FIG. 16 is a graph showing bit error rate as a function of crossover probability for N=128 nonidentical binary symmetric channels.

Corresponding reference numbers indicate corresponding parts throughout the drawings.

### DETAILED DESCRIPTION

This disclosure generally pertains to improvements in wireless communication systems employing OFDM. The inventors recognized that the underlying assumption that OFDM subcarrier channels have identical performance is incorrect. Moreover, the inventors recognized that user equipment (UE) measures signal-to-interference-plus-noise (SINR) by OFDM subcarrier channel and sends information about the measured SINR by OFDM subcarrier channel to the base station (e.g., gNodeB). Employing the measured SINR by OFDM subcarrier channel, it is possible to perform a simple permutation of the OFDM subcarrier assignment to improve communication (e.g., reduce bit error rate and/or achieve faster polarization). As will be described in greater detail below, in embodiments of the present disclosure, OFDM subcarrier assignments for coded bit transmissions are rearranged to minimize the BER, and to create a more consistent reliability sequence. This is equivalent to creating an adaptive polar code reliability sequence depending on the SINR report, although the same polar code Kronecker matric structure in the conventional one is used.

The study of polar code has exploded during the current and past decade since 2009 and recently has been applied for the 5G control channels. Also, cyclic redundancy code (CRC) has been concatenated as an outer code for an inner polar code. Furthermore, polar decoding has improved significantly after the appearance of the list decoding idea.

An identical binary input-discrete memoryless channel (BI-DMC) component channel W in a vector channel W^{N} has been assumed in most literature, where N is the codeword length, e.g., in the original polar code publication, CRC polar code, list polar decoding, and even the recently launched 5G polar code. In the present disclosure, the same BI-DMC component channel is assumed. And each coded bit is binary modulated, e.g., a binary phase shift keying (BPSK), and transmitted via an OFDM subcarrier channel. This is to investigate the effects of non-identical BI-DMCs on BER. A higher modulation than BPSK will be investigated in future.

A binary erasure channel (BEC) channel is a common model for polar coding literature to employ for ease of analysis and simulation. Much of the existing literature on polar coding uses the BEC model, as well as the original paper on polar coding by Arikan. In the present disclosure, both the BEC and binary symmetric channel (BSC) are considered.

Studies on non-identical BI-DMCs for polar code have been conducted. These studies focused on analytical proofs of polarization and symmetric capacity by employing interleaver and deinterleaver (referred to as permutation and depermutation in the present disclosure). In other words, they proved that the polar channel capacity can be achieved even if the components in the BI-DMC vector (i.e., parallel) are non-identical. They also didn't consider frozen and free bit assignments considering the non-identical BI-DMC. The ratio of the number of free bits to the codeword length (equal to the sum of the number of free and frozen bits) is a practical code rate. In the present disclosure a suboptimum OFDM subcarrier assignment scheme is presented which provides a lower bit error rate (BER) than the conventional polar code ones without considering permutation.

In the present disclosure, theoretical analysis is presented for beyond 5G (B5G) practical applications which focuses on a narrow scope of the channel environment: BEC erasure probability and BSC crossover probability of each component in a BI-DMC vector are known to both the transmitter and receiver (e.g., communication devices), and furthermore are not changing (i.e., deterministic) during a codeword transmission. Attention is paid to the BER, and decoding computational complexity is kept as O(N log₂N) as in the original polar code of Kronecker matrix and successive cancellation (SC). Additionally, an alternative proof of BEC and BSC polar channel capacity is provided which doesn't rely on the Bhattacharyya parameter. The symmetry of these equations is also presented, and a simplified flexible suboptimization method is introduced which takes very little computation.

The polar encoder takes N message bits and maps them into a codeword of length N. The N message bits consist of K free message bits and N−K frozen message bits, which are typically set to 0 bits, and K depends on the polar code rate R=K/N.

The reliability sequence in the existing polar FEC code has been designed and is used to determine which channels to use for transmission. An N×N Kronecker matrix is used for N=2^{l} polar encoding, where l is an integer representing a coordinate. The more an input bit is used in the code word construction, the more reliable in general it is. The true sequence of reliability, however, is much more non-static. Hence, the current reliability sequence is based on the number of times it appears in the code word construction. Better determining reliability sequences is still an active area of study. The K free message bits and N−K frozen bits are assigned to higher and lower reliable sequence numbers, respectively.

Attention has not been paid to the orthogonal frequency division multiplexing (OFDM) subcarrier assignment for polar coded bit transmissions corresponding to the free and frozen bits. This is because all OFDM subcarrier channels are assumed to be identical and independent distribution (i.i.d.).

In practice, for example, in 5G (and a future B5G), the OFDM subcarrier channels may not be identical although they are independent, because each subcarrier channel environment may vary depending on the OFDM subcarrier index due to interference, fading, and mobility, etc.

In the 5G New Radio (NR) standards, it is required for a user equipment (UE) to report its measured signal-to-interference-plus-noise ratio (SINR) measured at the designated OFDM subcarrier reference symbols (RSs) to the connected gNodeB (e.g., base station node) aperiodically or periodically, e.g., every fourth slot. This report can be used for the channel quality indicator (CQI) at each OFDM subcarrier and for the resource block (RB) assignment at a medium access control (MAC) layer. The SINR measured at the OFDM subcarriers can vary across the OFDM subcarrier indices. If they are identical, it is not necessary for a UE to transmit a mandatory report of SINR.

In the literature, nonidentical component channel characteristics have not yet been considered and exploited much for polar code design. Hence, the existing polar codes may not achieve the best performance when the component channels are nonidentical.

This disclosure addresses the properties of polar code under non-identical conditions and provides for improved bit error rate performance for existing polar codes for B5G. This disclosure further proves that the polar code polarization processing can be faster under a nonidentical vector channel environment than an identical vector channel environment.

The 5G polar code has been used for a control channel. For B5G, a polar code can be employed for both control and data channels. Under this expectation, the following contributions and benefits can be achieved with the proposed simple polar code:

Embodiments of the present disclosure are compatible with existing systems because the same polar encoding structure with the Kronecker matrix in the existing 5G or B5G polar code system can be used.

Embodiments of the present disclosure do not require additional complexity because the 5G SINR report is available at both the UE and the gNodeB. Only simple permutation is necessary for the OFDM subcarrier assignment, which can be implemented at both the UE and the gNodeB MAC layers. Thus, aspects of the present disclosure (e.g., generating the reliability sequence and/or permuting the OFDM subcarrier channels) may be performed at the MAC layer of either the gNodeB (e.g., a base station node) or the user equipment (e.g., a cellular device).

Moreover, in this disclosure, it is found that a polar code can show a quicker polarization under nonidentical channel environments if a correct permutation of the channels is applied when compared to identical channels.

Embodiments of the present disclosure under a nonidentical channel environment with simple OFDM subcarrier permutation can show a significantly lower BER than a conventional polar code designed without OFDM subcarrier permutation for coded bit transmissions.

Algorithm 1 is constructed as a simple, low compute, algorithm for maximizing capacity of free channels under non-identical conditions.

A polar codeword is generated as a linear block code of length N, i.e., a codeword is the product of an input message block of N bits times an N×N generator matrix G. For example, for N=4, (X₀, X₁, X₂, X₃)=(U₀, U₁, U₂, U₃) G⁽²⁾ where (X₀, X₁, X₂, X₃) and (U₀, U₁, U₂, U₃) are respectively, the output and input of the Kronecker generator block matrix G, i.e., the codeword and the message word, and

$${G}_{( {2}^{l} \times {2}^{l} )} = [ \begin{matrix}{G}^{( l - 1 )} & 0 \\ {G}^{( l - 1 )} & {G}^{( l - 1 )}\end{matrix} ]$$

is the i-fold Kronecker matrix, e.g.,

$${G}_{( {2}^{0} \times {2}^{0} )} = 1 and {G}_{( 2 \times 2 )} = [ \begin{matrix}1 & 0 \\ 1 & 1\end{matrix} ] .$$

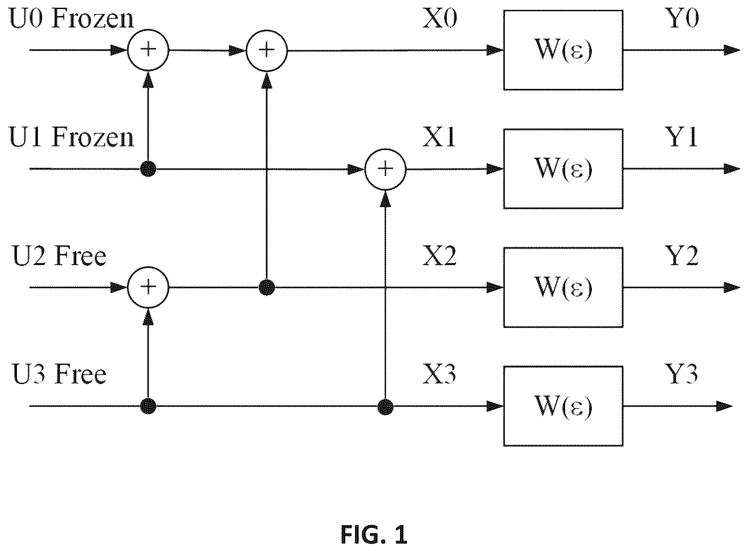

It has been assumed in most existing polar code literature that the component channel is an identical and independent BEC of a transition probability matrix W(ϵ). For example of N=4 in FIG. 1, each polar coded bit X₀=U₀+U₁, X₁=U₁+U₃, X₂=U₂+U₃, or X₃=U₃, has been transmitted through any BEC of W(ϵ).

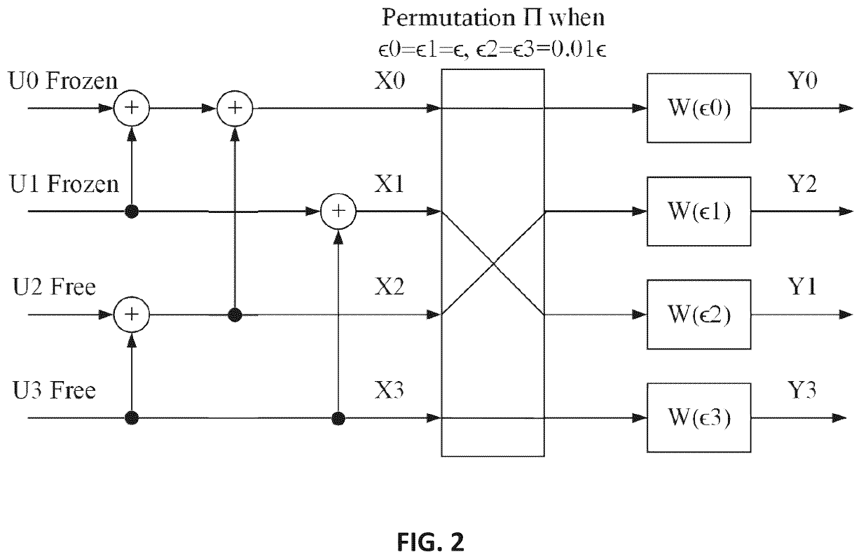

In practice, each component channel, e.g., the one shown in FIG. 2 for N=4, can be a nonidentical BEC of W(ϵ₀), W(ϵ₁), W(ϵ₂), and W(ϵ₃). This is because the SINRs of OFDM subcarrier channels can vary across the subcarrier frequency as well as the time in practice, and an OFDM subcarrier channel can be modeled as a BEC or a BSC when a binary modulation is employed and the codeword size N will be equal to the OFDM size. In addition, it is assumed that the erasure or the crossover probability is known to the encoder and decoder and deterministic during a codeword transmission.

For example, the received symbol can be written as y₀=x₀+n₀ under an additive white Gaussian noise (AWGN) channel, where x₀ is a binary phase shift keying (BPSK) transmitted symbol of unit power, and n₀ is an AWGN of power σₙ². Then, SINR=1/σₙ². Suppose that the receiver makes a hard decision with threshold Th and erases y₀ when y₀ is in an ambiguity decision region, such as the region between a lower threshold −Th and an upper Th. Then, the erasure probability can be written as

$$ϵ = Q ( ( 1 - Th ) \sqrt{SINR} ) - Q ( ( 1 + Th ) \sqrt{SINR} ) \qquad ( 1 )$$

$$where$$

$$Q ( α ) = {\int }_{α}^{∞} \frac{1}{\sqrt{2 π}} {e}^{- {t}^{2} / 2} dt \qquad ( 2 )$$

is the tail probability of the normal density function. Thus, the received OFDM subcarrier channels can be nonidentical if they have nonidentical SINRs. Some of the component channels have higher erasure probabilities while others have lower probabilities depending on each OFDM subcarrier's SINR.

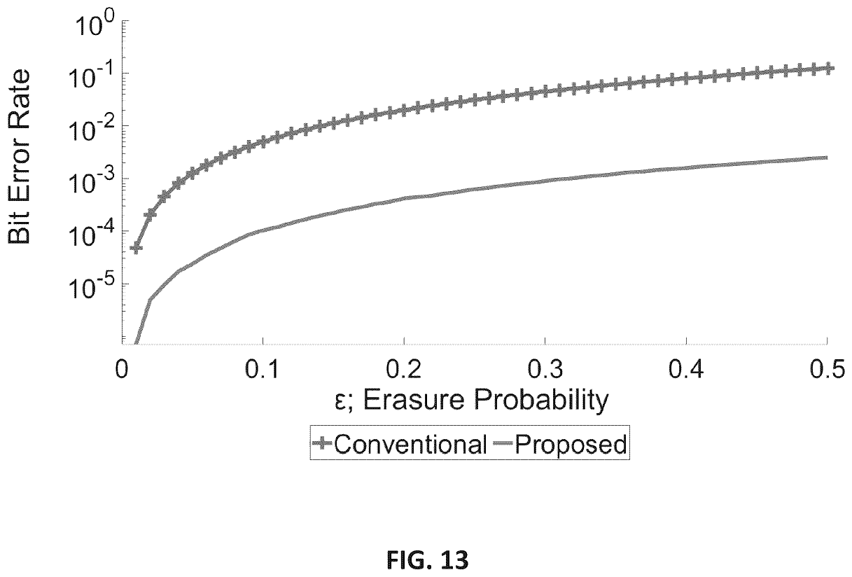

A higher modulation case will be investigated in future. A higher modulation will reduce the number of OFDM subcarrier channels from N to N/log₂M when an M-ary modulation is used before an OFDM processing. This is because each OFDM subcarrier channel will deliver log 2M coded bits. Still, the significant BER improvements shown in FIG. 13 and described below are expected even for a higher modulation by applying the following: permutation of OFDM subcarriers depending on the subcarrier channel conditions. This is because the OFDM subcarrier channels will not be identical in practice and the positive effects of OFDM subcarrier permutation, which will be presented later in the present disclosure for M=2, are still expected for log₂M number of polar coded bit transmissions per OFDM subcarrier.

Furthermore, an existing 5G UE is required to report its measured SINR at specified 5G OFDM channel state information-reference symbol (CSI-RS) subcarriers to a connected gNodeB periodically or non-periodically, e.g., every fourth slot interval, 233.52 μs when subcarrier spacing is 240 kHz.

In the present disclosure, for example, it is proposed to transmit the coded bits X₀, X₁, X₂, X₃ via the OFDM subcarrier channels with erasure probabilities W(ϵ₀), W(ϵ₂), W(ϵ₂), W(ϵ₃), respectively, using a simple permutation matrix II, as shown at FIG. 2. For simplicity, examination of erasure probability is split into two groups. The BEC channels are grouped into a bad quality channel group and a good quality channel group such as ϵ₀=ϵ₁=ϵ and ϵ2=ϵ3=0.01ϵ where ϵ represents an identical BEC erasure probability from 0 to 0.5. This example is corresponding to the case of SINR₀=SINR₁≤SINR₂=SINR₃. The permutation in FIG. 2 is the optimal transmission strategy under these conditions.

The existing polar code, which does not exploit the OFDM subcarrier SINR reports, i.e., no permutation, may transmit the coded bits X₀, X₁, X₂, X₃ via the OFDM subcarrier channels with erasure probabilities W(ϵ₀), W(ϵ₁), W(ϵ₂), W(ϵ₃), respectively, as shown in FIG. 1. Then, this may (depending on the random quality of the current channels) yield a worse BER. On the other hand, embodiments of the present disclosure choose OFDM subcarrier channels adaptively so the BER can be minimized.

The proposed permutation has multiple purposes. Firstly, the reliability sequence in polar code, even under identical channels, is non-static. Under non-identical conditions the uncertainty of the reliability sequence increases all the more. Hence, it first serves the purpose of creating a consistent reliability sequence within the system. Second, the allocation of channel capacities is subject to change, depending on the permutation of the channels. A permutation described in greater detail below maximizes the U2 bit channel; this permutation makes finding the reliability sequence simple, along with allocating most of the capacity to half the channels under the assumed conditions.

Note that the proposed polar code structure shown in FIG. 2 before permutation matrix Π is the same as that of the existing polar code built on the Kronecker matrix shown in FIG. 1. Hence, the additional complexity to implement the proposed polar code is minimal.

### I. Analysis

When the OFDM subcarriers are identical, the transition probability W(ϵ) of BEC is written for the ith OFDM subcarrier, i=0, . . . , N−1, as

$$W = [ \begin{matrix}1 - ϵ & for & ( {X}_{i} = 1 , {Y}_{i} = 1 ) \\ ϵ & for & ( {X}_{i} = 1 , {Y}_{i} = erased ) \\ ϵ & for & ( {X}_{i} = 0 , {Y}_{i} = erased ) \\ 1 - ϵ & for & ( {X}_{i} = 0 , {Y}_{i} = 0 )\end{matrix} ] . \qquad ( 3 )$$

Assume that each polar encoded bit is transmitted via an i.i.d. BEC channel of transition probability W(ϵ) with codeword length N, K free bits, and (N−K) frozen bits. Presently, N=4 and K=2 are taken as an example to deliver benefits of the proposed system, which can be extended for a higher codeword length N=2^{l}, where l is a positive integer. Each component channel shown in FIGS. 1 and 2 is a BEC of either erasure probability Ei for identical channels or Ei for nonidentical channels, where i denotes the OFDM subcarrier channel index, i=0, 1, . . . , N−1. The average of Ei is chosen to be equal to c for fair comparison between the nonidentical channels and the identical channels. For BSC, the erasure probability Ei is replaced with the crossover probability pᵢ.

### A. Reliability Sequence

In the original polar code and in most existing literature, including the 5G standards, the identical BEC N-dimensional vector model has been used, as shown in FIG. 1. The input bits U₀, U₁, U₂, and U₃ are used once, twice, twice, and four times in the code bit construction X₀, X₁, X₂, and X₃, respectively, and the polarized channel capacity I(W^{s}^{₀}^{s}^{₁}) of second-level bit coordinates shows an increasing order of I(W⁻⁻)≤I(W⁻⁺)≤I(W⁺⁻)≤I(W⁺⁺), where the superscript s₀s₁ . . . sₗ₋₁ is a binary sequence of l bits representing integer i=0, . . . , 2^{l}−1, and sᵢ=− and sᵢ=+ mean 0 and 1, respectively. This is why the reliability sequence in the existing literature is determined as (0, 1, 2, 3) as shown in FIG. 1, assuming that the component channel is identical and independent. Hence, the frozen and free message bits are assigned to (U₀, U₁) and (U₂, U₃), respectively, when code rate Rₑ=½ and K=2. The frozen bits are known to both the polar encoder and decoder.

The polarized channel for N=4 with capacity I(W⁻⁻), I(W⁻⁺), I(W⁺⁻), and I(W⁺⁺) represent the mutual information I(U₀; Y³, U⁻¹)), I(U₁; Y³, U⁰)), I(U₂; Y³, U¹)), I(U₃; Y³, U²)), respectively, where Y³ and Uⁱ denotes (Y₀, Y₁, Y₂, Y₃) and (U₀, . . . , Uᵢ), respectively, and U⁻¹ denotes the null set.

For N=8, the input bits U₀, U₁, U₂, U₃, U₄, U₅, U₆, and U₇ are used once, twice, twice, four times, twice, four times, four times, and eight times in the code bit construction X₀, X₁, X₂, X₃, X₄, X₅, X₆, and X₇, respectively, and I(W⁻⁻⁻)≤I(W⁻⁻⁺)≤I(W⁻⁺⁻)≤I(W⁺⁻⁻)≤I(W⁻⁺⁺)≤I(W⁺⁻⁺)≤I(W⁺⁺⁻)≤I(W⁺⁺⁺). This is why the reliability sequence is determined as (0, 1, 2, 4, 3, 5, 6, 7) assuming that the component channel is identical and independent. Hence, the frozen and free message bit are assigned to (U₀, U₁, U₂, U₄), and (U₃, U₅, U₆, U₇), respectively, instead (U₀, U₁, U₂, U₃) and (U₄, U₅, U₆, U₇) when code rate Rₑ=½ and K=4.

This acts as a method of estimating the reliability sequence of a polar code channel, but the actual reliability sequence changes even under identical conditions. Under non-identical conditions these changes become more drastic and unstable.

### B. Capacity Analysis for Binary Erasure Channel

The negatively polarized channel W⁻ or positively polarized channel W⁺ for the polar code is a mapping from a frozen bit U₀ or a free bit U₁ to (Y₀, Y₁) for N=2. The equivalent erasure probability for the negatively (i.e., s₀=−) or positively (i.e., s₀=+) polarized channel in the identical channels in the existing polar code system can be written as

$${f}^{{s}_{0}} ( ϵ ) = [ \begin{matrix}2 ϵ - {ϵ}^{2} if {s}_{0} = - \\ {ϵ}^{2} if {s}_{0} = +\end{matrix} ] . \qquad ( 4 )$$

Hence, the conventional polar code capacities for the identical BEC channels of transition probability matrix W(ϵ) can be written as

$$I ( {W}^{-} ( ϵ ) ) = 1 - {f}^{-} ( ϵ ) = 1 - ( 2 ϵ - {ϵ}^{2} ) = {( 1 - ϵ )}^{2}$$

$$and$$

$$I ( {W}^{+} ( ϵ ) ) = 1 - {f}^{+} ( ϵ ) = 1 - {ϵ}^{2}$$

For a general N=2^{l}, the equivalent erasure probability for the s₀, . . . , sₗ₋₁ polarized channel in the existing identical channels can be written as

$${ϵ}_{{W}^{{s}_{0} \cdot {s}_{1} , … , {s}_{l - 2} , {s}_{1 - 1}}} = {f}^{{s}_{1 - 1}} ( {f}^{{s}_{l - 2}} ( … {f}^{{s}_{1}} ( {f}^{{s}_{0}} ( ϵ ) ) … ) ) \qquad ( 7 )$$

and the conventional polar code capacities for the identical BEC channels of W(ϵ) can be written as

$$\begin{matrix}I ( {W}^{{s}_{0} , … , {s}_{l - 1}} ) = 1 - {ϵ}_{{W}^{{s}_{0} . {s}_{1} , … , {s}_{l - 2} , {s}_{l - 1}}} \\ = 1 - {f}^{{s}_{l - 1}} ( {f}^{{s}_{l - 2}} ( … {f}^{{s}_{1}} ( {f}^{{s}_{0}} ( ϵ ) ) … ) ) .\end{matrix}$$

The corresponding equivalent erasure probability for the N=2 negatively (i.e., s₀=−) or positively (i.e., s₀=+) polarized channel in the nonidentical OFDM channels can be written as

$${f}^{{s}_{0}} [ \begin{matrix}{ϵ}_{0} \\ {ϵ}_{1}\end{matrix} ] = [ \begin{matrix}{ϵ}_{0} + {ϵ}_{1} - {ϵ}_{0} {ϵ}_{1} if {s}_{0} = - \\ {ϵ}_{0} {ϵ}_{1} if {s}_{0} = +\end{matrix} ] . \qquad ( 9 )$$

Hence, the channel capacity for the N=2 nonidentical BEC channels can be written as

$$I ( {W}^{{s}_{0}} ) = 1 - {f}^{{s}_{0}} [ \begin{matrix}{ϵ}_{0} \\ {ϵ}_{1}\end{matrix} ] . \qquad ( 10 )$$

In other words,

$$I ( {W}^{-} ) = 1 - ( {ϵ}_{0} + {ϵ}_{1} - {ϵ}_{0} {ϵ}_{1} ) \qquad ( 11 )$$

$$and$$

$$I ( {W}^{+} ) = 1 - {ϵ}_{0} {ϵ}_{1} . \qquad ( 12 )$$

For N=4, the corresponding equivalent erasure probability for the s₀s₁=−−, −+, +−, and ++ polarized channels in the nonidentical OFDM channels can be written as

$${ϵ}_{{W}^{{s}_{0} , {s}_{1} ( {ϵ}_{0} , {ϵ}_{1} , {ϵ}_{2} , {ϵ}_{3} )}} = {f}^{{s}_{1}} [ \begin{matrix}{f}^{{s}_{0}} [ \begin{matrix}{ϵ}_{0} \\ {ϵ}_{1}\end{matrix} ] \\ {f}^{{s}_{0}} [ \begin{matrix}{ϵ}_{1} \\ {ϵ}_{3}\end{matrix} ]\end{matrix} ] . \qquad ( 13 )$$

Theorem 1. For N=21, the equivalent erasure probability for the polarized channels in the nonidentical component channels can be written as

$${ϵ}_{{W}^{{s}_{0} , … , {{s}_{l - 1}}_{( {ϵ}_{0} , {…ϵ}_{N - 1} )}}} = {f}^{{s}_{l - 1}} [ \begin{matrix}{f}^{{s}_{l - 2}} [ … {f}^{{s}_{2}} \begin{matrix}[ \begin{matrix}{f}^{{s}_{1}} [ \begin{matrix}{f}^{{s}_{0}} [ \begin{matrix}{ϵ}_{0} \\ {ϵ}_{N / 2}\end{matrix} ] \\ {f}^{{s}_{0}} [ \begin{matrix}{ϵ}_{N / 4} \\ {ϵ}_{N / 4 + N / 2}\end{matrix} ]\end{matrix} ] \\ {f}^{{s}_{1}} [ \begin{matrix}{f}^{{s}_{0}} [ \begin{matrix}{ϵ}_{N / 8} \\ {ϵ}_{N / 8 + N / 2}\end{matrix} ] \\ {f}^{{s}_{0}} [ \begin{matrix}{ϵ}_{N / 8 + N / 4} \\ {ϵ}_{N / 8 + N / 4 + N / 2}\end{matrix} ]\end{matrix} ]\end{matrix} ] \\ ⋮\end{matrix} … ] \\ {f}^{{s}_{l - 2}} [ … {f}^{{s}_{2}} \begin{matrix}⋮ \\ [ \begin{matrix}{f}^{{s}_{1}} [ \begin{matrix}{f}^{{s}_{0}} [ \begin{matrix}{ϵ}_{N - N / 8 - N / 4 - N / 2 - 1} \\ {ϵ}_{N -- N / 8 - N / 4 - 1}\end{matrix} ] \\ {f}^{{s}_{0}} [ \begin{matrix}{ϵ}_{N / - N / 8 - N / 2 - 1} \\ {ϵ}_{N - N / 8 - 1}\end{matrix} ]\end{matrix} ] \\ {f}^{{s}_{1}} [ \begin{matrix}{f}^{{s}_{0}} [ \begin{matrix}{ϵ}_{N - N / 2 - N / 4 - 1} \\ {ϵ}_{N - N / 4 - 1}\end{matrix} ] \\ {f}^{{s}_{0}} [ \begin{matrix}{ϵ}_{N - N / 2 - 1} \\ {ϵ}_{N / 1}\end{matrix} ]\end{matrix} ]\end{matrix} ]\end{matrix} ]\end{matrix} ] \qquad ( 14 )$$

Therefore, the corresponding polar code capacities for the nonidentical equivalent BEC channels of the W^{s}^{₀}^{, . . . , s}^{ₗ₋₁}(ϵ₀, . . . , ϵ_{N-1}) transition probability matrix can be written as

$$\begin{matrix}I ( {W}^{{s}_{0} , … , {s}_{l - 1}} ( {ϵ}_{0} , … , {ϵ}_{N - 1} ) ) \\ = 1 - {ϵ}_{{W}^{{s}_{0} , … , {{s}_{l - 1}}_{( {ϵ}_{0} , {…ϵ}_{N - 1} )}}} .\end{matrix} \qquad ( 15 )$$

Proof. The proof is completed with an induction method by applying for index l and quoting (9) for N=2, i.e., l=1 and (48) for N=4, i.e., l=2.

Remark: Equation (14) is an equivalent erasure probability in a closed form for the {s₀, . . . , sₗ₋₁} polarized channels when the non-identical erasure probability set {ϵ₀, . . . , ϵ_{N-1}} is known to the transmitter and receiver during a codeword transmission period. This is feasible because the 5G SINR report is mandatory. In addition, the resource block assigned by a gNodeB is within a channel coherence interval. This closed form is usable in the quick search of a suboptimum permutation. It can be also exploitable for a brute force optimum search, but the computational complexity increases prohibitively due to a large number of possible permutations in {ϵ₀, . . . , ϵ_{N-1}} as N increases. Therefore, a suboptimum search, e.g., Algorithm 1 below recommended for practical application. In the present disclosure, (14) can be utilized for a practical B5G application.

Theorem 2. For fair comparison between an identical and a nonidentical BEC, assume that the average erasure probability for the nonidentical BECs is equal to the identical BEC erasure probability:

$$ϵ = \frac{1}{N} {\sum }_{i = 0}^{N - 1} {ϵ}_{i} , 0 \leq {ϵ}_{i} \leq 1. \qquad ( 16 )$$

Then, a polar code positively polarization capacity under nonidentical BEC channels is greater than or equal to a polar code positively polarization capacity under identical BEC channels, i.e.,

$$\begin{matrix}{I}_{iden} ( {W}^{{s}_{0} = + , … , {s}_{l - 1} = +} ) ( ϵ , … , ϵ ) ) \\ \leq {I}_{noniden} ( {W}^{{s}_{0} = + , … , {s}_{l - 1} = +} ( {ϵ}_{0} , … , {ϵ}_{N - 1} ) ) .\end{matrix} \qquad ( 17 )$$

### Proof Let

$${ϵ}_{i} = {a}_{i} ϵ , 0 \leq {ϵ}_{i} \leq 1 , 0 \leq {a}_{i} \leq N , i = 0 , … , N - 1.$$

### From (16)

$$\frac{1}{N} {\sum }_{n = 0}^{N - 1} {a}_{i} = 1. \qquad ( 18 )$$

### From (8), (14), and (15),

$${I}_{iden} ( {W}^{{s}_{0} = + , … , {s}_{l - 1} = +} ( ϵ , … , ϵ ) ) = 1 - {ϵ}^{N} \qquad ( 19 )$$

$${I}_{noniden} ( {W}^{{s}_{0} = + , … , {s}_{l - 1} = +} ( {ϵ}_{0} , … , {ϵ}_{N - 1} ) ) = 1 - {\sum }_{i = 0}^{N - 1} {ϵ}_{i} . \qquad ( 20 )$$

### From (19) and (20),

$$\begin{matrix}{I}_{noniden} ( {W}^{{s}_{0} = + , … , {s}_{l - 1} = +} ( {ϵ}_{0} , … , {ϵ}_{N - 1} ) ) \\ - {I}_{iden} ( {W}^{{s}_{0} = + , … , {s}_{l - 1} = +} ( ϵ , … , ϵ ) ) \\ = {ϵ}^{N} - {\prod }_{i = 0}^{N - 1} {ϵ}_{i} = {ϵ}^{N} ( 1 - {\prod }_{i = 0}^{N - 1} {a}_{i} ) \geq 0.\end{matrix} \qquad ( 21 )$$

The last inequality is from the fact that a geometric mean is smaller than or equal to an arithmetic mean, i.e.,

$${( {\prod }_{i = 0}^{N - 1} {a}_{i} )}^{\frac{1}{N}} \leq \frac{1}{N} {\sum }_{i = 0}^{N - 1} {a}_{i} = 1. \qquad ( 22 )$$

### Therefore,

$$\begin{matrix}{I}_{iden} ( {W}^{{s}_{0} = + , … , {s}_{l - 1} = +} ( ϵ , … , ϵ ) ) \\ \leq {I}_{noniden} ( {W}^{{s}_{0} = + , … , {s}_{l - 1} = +} ( {ϵ}_{0} , … , {ϵ}_{N - 1} ) ) .\end{matrix} \qquad ( 23 )$$

Also, it can be shown that the polar code negatively polarization capacity under a nonidentical channel environment is lower than or equal to a polar code negatively polarization capacity under an identical channel environment, i.e.,

$$\begin{matrix}{I}_{iden} ( {W}^{{s}_{0} = - , … , {s}_{l - 1} = -} ( ϵ , … , ϵ ) ) \\ \geq {I}_{noniden} ( {W}^{{s}_{0} = - , … , {s}_{l - 1} = -} ( {ϵ}_{0} , … , {ϵ}_{N - 1} ) ) .\end{matrix} \qquad ( 24 )$$

Therefore, a nonidentical vector channel can yield an improved polarization for a polar code than an identical vector channel.

### C. Successive Cancellation Decoding

Successive cancellation (SC) is used for the polar decoding. For example, the codeword length is N=2, and a received vector y=(y₀, y₁) is available. Then, the log likelihood ratio (LLR) for an erasure channel can be written as

$$\begin{matrix}LLR ( {u}_{0} ) := LLR ( {u}_{0} \vert y ) \\ ≃ sign ( LLR ( {x}_{0} \vert {y}_{0} ) sign ( LLR ( {x}_{1} \vert {y}_{1} ) ) ) \\ \times min ( \vert LLR ( {x}_{0} \vert {y}_{0} ) \vert , \vert LLR ( {x}_{1} \vert {y}_{1} ) \vert ) )\end{matrix} \qquad ( 25 )$$

And the corresponding decided bit can be written as

$${\hat{u}}_{0} = [ \begin{matrix}0 & if & {u}_{0} is a frozen bit \\ 0 & else if & LLR ( {u}_{0} ) > 0 \\ 1 & otherwise & \end{matrix} ] \qquad ( 26 )$$

where for a BEC

$$\begin{matrix}LLR ( {x}_{i} \vert {y}_{i} ) = log \frac{Pr ( {x}_{i} = 0 \vert {y}_{i} )}{Pr ( {x}_{i} = 1 \vert {y}_{i} )} \\ = [ \begin{matrix}∞ & if & {y}_{i} = 0 \\ - ∞ & if & {y}_{i} = 1 \\ 0 & if & {y}_{i} = e ( i . e . , erased )\end{matrix} ] .\end{matrix} \qquad ( 27 )$$

By cancelling û₀ in x₀, the û₁ can be found as

$${\hat{u}}_{1} = [ \begin{matrix}0 & if & {u}_{1} is a frozen bit \\ 0 & else if & LLR ( {u}_{1} ) > 0 \\ 1 & otherwise & \end{matrix} ] \qquad ( 28 )$$

$$where$$

$$\begin{matrix}LLR ( {u}_{1} ) := LLR ( {u}_{1} \vert y ) \\ = LLR ( {x}_{1} \vert {y}_{1} ) + {( - 1 )}^{{\hat{u}}_{0}} LLR ( {x}_{0} \vert {y}_{0} ) .\end{matrix} \qquad ( 29 )$$

### D. N=2 Theoretical BER

The exact BER analysis for a general codeword length N is not simple because of the SC iteration processing and is left for future work. A min-sum based theoretical BER approximation is presented for N=2 case.

Theorem 3. Bit error rate of a polar code with N=2 codeword length and successive cancellation decoding can be approximated with (25) under a nonidentical BEC vector channel (W (ϵ₀), W (ϵ₁)) as

$${P}_{b} ( E ) ≃ {ϵ}_{0} {ϵ}_{1} \qquad ( 30 )$$

Proof. Assume that U₀=0 is the frozen bit and known to both the transmitter and receiver. Then, the BER can be written as

$$\begin{matrix}{P}_{b} ( E ) = {P}_{b} ( E \vert {U}_{1} = 0 ) Pr ( {U}_{1} = 0 ) \\ + {P}_{b} ( E \vert {U}_{1} = 1 ) Pr ( {U}_{1} = 1 ) \\ = \frac{1}{2} {P}_{b} ( E \vert {U}_{1} = 0 ) + \frac{1}{2} {P}_{b} ( ( E \vert {U}_{1} = 1 ) .\end{matrix} \qquad ( 31 )$$

$$Then ,$$

$$\begin{matrix}{P}_{b} ( E \vert {U}_{1} = 0 ) = 1 - Pr ( C \vert {U}_{1} = 0 ) \\ = 1 - Pr ( {U}_{1} = {U}_{1} \vert {U}_{1} = 0 ) = 1 - ( 1 - {ϵ}_{0} {ϵ}_{1} ) = {ϵ}_{0} {ϵ}_{1} .\end{matrix} \qquad ( 32 )$$

The 3rd equality in (32) is derived with (27), (28), and (29) as below.

$$\begin{matrix}Pr [ {\hat{U}}_{1} = 0 \vert {U}_{1} = 0 ] = Pr [ LLR ( {\hat{U}}_{1} ) > 0 \vert {U}_{1} = 0 ] \\ = Pr [ LLR ( {X}_{1} \vert {Y}_{1} ) + {( - 1 )}^{{\hat{U}}_{0} = 0} LLR ( {X}_{0} \vert {Y}_{0} ) > 0 \vert {U}_{1} = 0 ] \\ = Pr [ LLR ( {X}_{1} \vert {Y}_{1} ) + LLR ( {X}_{0} \vert {Y}_{0} ) > 0 \vert {U}_{1} = 0 ] \\ = Pr [ \{ LLR ( {X}_{1} \vert {Y}_{1} ) > 0 ⋂ LLR ( {X}_{0} \vert {Y}_{0} ) = 0 \} \\ ⋃ \{ LLR ( {X}_{1} \vert {Y}_{1} ) = 0 ⋂ LLR ( {X}_{0} \vert {Y}_{0} ) > 0 \} \vert {U}_{1} = 0 ] \\ ⋃ \{ LLR ( {X}_{1} \vert {Y}_{1} ) > 0 ⋂ LLR ( {X}_{0} \vert {Y}_{0} ) > 0 \} \vert {U}_{1} = 0 ] \\ = Pr [ \{ {Y}_{1} = 0 ⋂ {Y}_{0} = e \} \vert {U}_{1} = 0 ] \\ + Pr [ \{ {Y}_{1} = e ⋂ {Y}_{0} = 0 \} \vert {U}_{1} = 0 ] \\ + Pr [ \{ {Y}_{1} = 0 ⋂ {U}_{0} = 0 \} \vert {U}_{1} = 0 ] \\ = ( 1 - {ϵ}_{1} ) {ϵ}_{0} + {ϵ}_{1} ( 1 - {ϵ}_{0} ) + ( 1 - {ϵ}_{1} ) ( 1 - {ϵ}_{0} ) \\ = 1 - {ϵ}_{1} {ϵ}_{0} .\end{matrix} \qquad ( 33 )$$

Similarly, it can be shown that

$$Pr [ {U}_{1} = 1 \vert {U}_{1} = 1 ) ] = 1 - {ϵ}_{1} {ϵ}_{0} . \qquad ( 34 )$$

Therefore, (30) holds.

The BER is not changed for a N=2 polar code when a coded bit X₁ is transmitted through a better or a worse channel, i.e., when a worse BEC of ϵ₀ channel and a better BEC channel of Ei are swapped. This is because BER in (30) is symmetric in ϵ₀ and ϵ₁. However, this symmetry is broken when N≥4 depending on the combinations of better and worse BEC channels, e.g., the one in FIG. 2 is the best while the one in FIG. 1 is the worst. If there is no permutation under a nonidentical BEC vector channel environment, then the conventional polar code as shown in FIG. 1 can perform the worst. This will be discussed in greater detail below.

### E. Capacity Analysis for Binary Symmetric Channel

The transition probability W(p) of a BSC in an identical OFDM subcarrier vector channel corresponding to (3) of BEC is written as

$$W ( p ) = [ \begin{matrix}1 - p & for & {X}_{i} = {Y}_{i} \\ p & for & {X}_{i} \neq {Y}_{i}\end{matrix} ] \qquad ( 35 )$$

where p is the crossover probability, i=0, . . . , N−1.

For N=2^{l}, the equivalent BSC crossover probability p_{W}_{^{s0 . . . sl-1}}₍ₚ_{⁰}_{, . . . , p}_{^{N-1}}₎ for the {s₀, . . . , sₗ₋₁} polarized channels in the nonidentical OFDM subcarrier vector channel can be written by replacing the erasure probability Ei with the BSC crossover probability pᵢ. Justification is the same as the one used for the BEC vector channel case. For example, suppose N=2. Then, U₀ can be recovered correctly only if both Y₀ and Y₁ are not crossed over. Hence, the corresponding equivalent crossover probability for the nonidentical BSC channels of W(pᵢ) for i=0, 1, can be written as

$${p}_{{W}^{-}} = 1 - ( 1 - {p}_{0} ) ( 1 - {p}_{1} ) = {p}_{0} + {p}_{1} - {p}_{0} {p}_{1} \qquad ( 36 )$$

which is corresponding to (9). The sum of p_{W}_{^{−}} and p_{W}_{⁺} should be equal to the sum of p₀ and p₁. Therefore, the corresponding equivalent crossover probability for the N=2 positively (i.e., s₀=+) polarized channel in the nonidentical OFDM channels can be written as

$${p}_{{W}^{+}} = {p}_{0} + {p}_{1} - {p}_{{W}^{-}} = {p}_{0} {p}_{1} . \qquad ( 37 )$$

In summary, the corresponding equivalent crossover probability for the N=2 negatively (i.e., s₀=−) or positively (i.e., s₀=+) polarized channel in the nonidentical OFDM channels can be written as (9) by replacing ϵᵢ with pᵢ:

$${f}^{{s}_{0}} [ \begin{matrix}{p}_{0} \\ {p}_{1}\end{matrix} ] = [ \begin{matrix}{p}_{0} + {p}_{1} - {p}_{0} {p}_{1} if {s}_{0} = - \\ {p}_{0} {p}_{1} if {s}_{0} = +\end{matrix} ] . \qquad ( 38 )$$

This can be extended for N=2^{l} as in (14) by replacing ϵᵢ with pᵢ.

The channel capacity for the N=2 nonidentical BSC channels can be written as

$$I ( {W}^{{s}_{0}} ) = 1 - ℋ ( {p}_{{W}^{{s}_{0}}} ) \qquad ( 39 )$$

where [symbol] (p_{W}_{^{s}}₀) denotes the binary entropy function, i.e.,

$$ℋ ( {p}_{{W}^{{s}_{0}}} ) = {{p}_{W}}^{{s}_{0}} log ( \frac{1}{{p}_{{W}^{{s}_{0}}}} ) + ( 1 - {p}_{{W}^{{s}_{0}}} ) log ( \frac{1}{1 - {p}_{{W}^{{s}_{0}}}} ) . \qquad ( 40 )$$

The channel capacity for an N=2^{l} nonidentical BSC vector channel can be written as

$$\begin{matrix}I ( {W}^{{s}_{0} , … , {s}_{l - 1}} ( {p}_{0} , … , {p}_{N - 1} ) ) \\ = 1 - ℋ ( {p}_{{W}^{{s}_{0} , … , {{ϑ}_{l - 1}}_{( {p}_{0} , … , {p}_{N - 1} )}}} ) .\end{matrix} \qquad ( 41 )$$

The polarized channel capacity and BER results for the BSC and other channels such as AWGN and Rayleigh fading can be derived as done for a BEC by replacing LLR in (27).

For a BSC channel:

$$\begin{matrix}LLR ( {x}_{i} \vert {y}_{i} ) = log \frac{Pr ( {x}_{i} = 0 \vert {y}_{i} )}{Pr ( {x}_{i} = 1 \vert {y}_{i} )} \\ = [ \begin{matrix}log ( \frac{1 - {p}_{i}}{{p}_{i}} ) & if & {y}_{i} = 0 \\ log ( \frac{{p}_{i}}{1 - {p}_{i}} ) & if & {y}_{i} = 1\end{matrix} ] = {( - 1 )}^{{y}_{i}} log ( \frac{1 - {p}_{i}}{{p}_{i}} ) .\end{matrix} \qquad ( 42 )$$

For an AWGN channel of noise variance σ²:

$$LLR ( {x}_{i} \vert {y}_{i} ) = log \frac{Pr ( {x}_{i} = 0 \vert {y}_{i} )}{Pr ( {x}_{i} = 1 \vert {y}_{i} )} = \frac{2 {y}_{i}}{{σ}^{2}} . \qquad ( 43 )$$

For a Rayleigh fading channel of noise variance σ² and fading channel coefficient αᵢ:

$$LLR ( {x}_{i} \vert {y}_{i} ) = log \frac{Pr ( {x}_{i} = 0 \vert {y}_{i} )}{Pr ( {x}_{i} = 1 \vert {y}_{i} )} = \frac{2 {α}_{i} {y}_{i}}{{σ}^{2}} . \qquad ( 44 )$$

### II. Results and Discussion

For fair comparison, an identical and a nonidentical erasure channel vector are chosen to satisfy the following condition:

$${ϵ}_{sum} = {\sum }_{i = 0}^{N - 1} {ϵ}_{i} = {N}_{ϵ} \qquad ( 45 )$$

where ϵ and ϵᵢ denote the erasure probability of an identical and a nonidentical BEC component channel, respectively, i=0, . . . , N−1. For example, in the present disclosure, half of channels are as bad as ϵᵢ=2×0.99×ϵ for i=0, . . . , N/2−1 due to the existence of an intentional interference, e.g., jamming, and the other half of the channels are as good as ϵᵢ=2×0.01×ϵ for i=N/2, . . . , N−1. Since 0≤ϵ₀≤1, the valid range for ϵ becomes

$$0 \leq ϵ \leq \frac{1}{2 \times 0.99} = 0.505 .$$

### A. Capacity Under Non-Identical Conditions

The exact effect of non-identical channels on the capacity of the individual channel channels varies, especially in high N cases. As such, examination is limited to the case where there are half good quality channels and half bad quality channels, such that SINRⱼ≥SINRᵢ, iϵ{0, . . . , N/2−1}, jϵ{N/2, . . . , N−1}. The necessary mathematical tools to evaluate and design solutions for more level scenarios are left for future work.

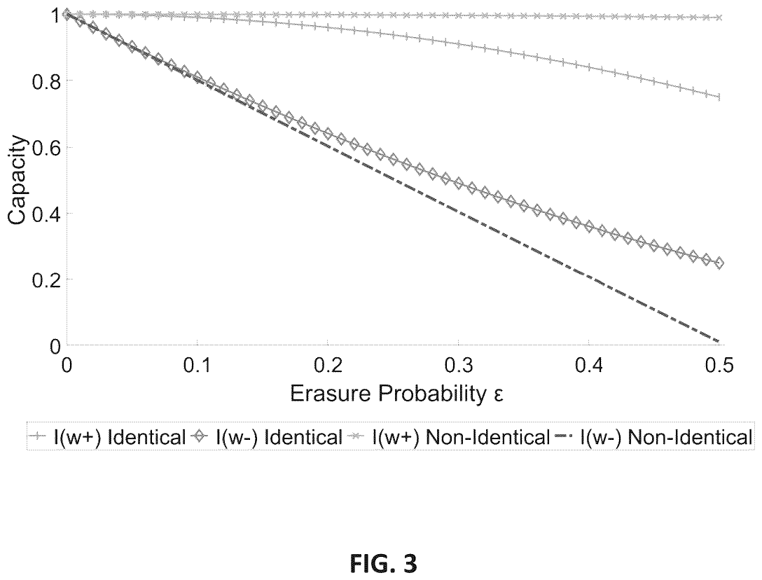

The capacity of the N=2 polar code channels under non-identical conditions and identical conditions will be considered first. The capacity of this channel is shown in FIG. 3 where c is the erasure probability for the identical case and also the average value of erasure probabilities for the non-identical case. In the N=2 case, due to the symmetric properties in (9), both capacities I(W⁻) in (11) and I(W⁺) in (12) are unaffected by any permutations of the channel qualities in the non-identical case. This example shows why it is useful to think of the capacities during permutation of channels as coming in pairs. The equations in (14) take in pairs of probabilities. For example, the capacities before and after permutation for the N=2 case are equivalent due to the symmetry as shown in the following equations (46) and (47), respectively:

$$I ( {W}_{no swap} ) = 1 - f [ \begin{matrix}{ϵ}_{0} \\ {ϵ}_{1}\end{matrix} ] . \qquad ( 46 )$$

$$I ( {W}_{swap} ) = 1 - f [ \begin{matrix}{ϵ}_{1} \\ {ϵ}_{0}\end{matrix} ] \qquad ( 47 )$$

However, the pairing of these channels can make the largest difference after permutation when N>2 cases. For example, consider the N=4 case.

$$I ( {W}^{{s}_{0} {s}_{1}} ) = 1 - {f}^{{s}_{1}} [ \begin{matrix}{f}^{{s}_{0}} [ \begin{matrix}{ϵ}_{0} \\ {ϵ}_{2}\end{matrix} ] \\ {f}^{{s}_{0}} [ \begin{matrix}{ϵ}_{0} \\ {ϵ}_{3}\end{matrix} ]\end{matrix} ] . \qquad ( 48 )$$

First, observe that the capacities of all negatively and positively polarized channels, i.e., s₀s₁=(−−) and (++), are static, i.e., no change regardless of permutation for a given set of Ei values due to symmetry observed in the N=2 case. For a higher N>2, all the negatively and positively polarized channels, i.e., (s₀, . . . , sₗ₋₁)=(−, . . . , −) and (+, . . . , +), are still symmetric and not changed after permuting ϵᵢ with ϵⱼ. Hence, most change will be observed in the channels that use a greater mixture of + and − values.

It is observed in FIG. 3 that when ϵ=0.505, I(W⁺(ϵ₀, ϵ₁))=0.9899, I(W⁺(ϵ))=0.7449, I(W⁻(ϵ))=0.2450, and I(W⁻(ϵ₀, ϵ₁))=0. Therefore, the positively and negatively polarized channel for the polar code under nonidentical BEC channels can achieve 1.3289 and ∞ times higher and lower than those of the polar code under identical BEC channels, respectively.

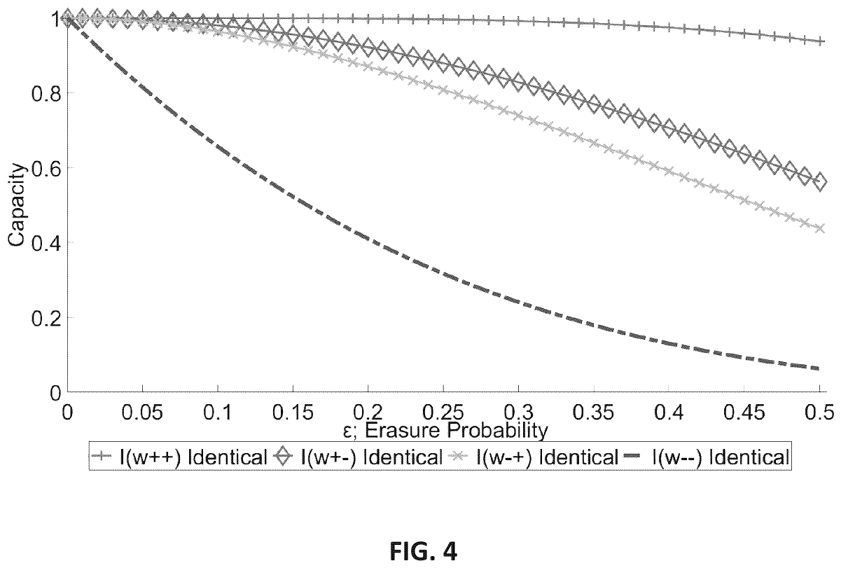

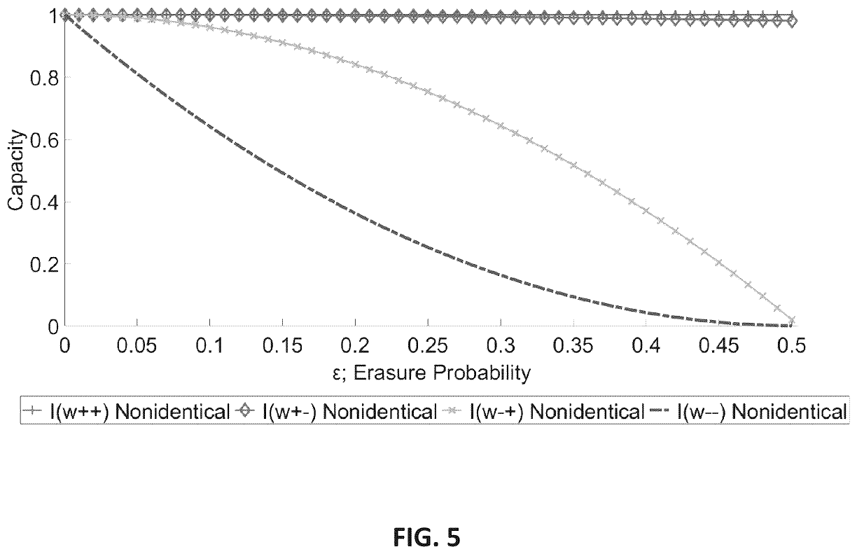

FIG. 4 shows four channel capacities I(W⁺⁺), I(W⁺⁻), I(W⁻⁺), and I(W⁻⁻) for N=4 identical channels. FIG. 5 also shows four channel capacities I(W⁺⁺), I(W⁺⁻), I(W⁻⁺), and I(W⁻⁻) for N=4 nonidentical channels.

Next is examining the N=4 case. It is observed in FIG. 4 at ϵ=0.505 that I(W⁻⁻), I(W⁻⁺), I(W⁺⁻), and I(W⁺⁺) are, respectively, 0.0600, 0.4300, 0.5549, and 0.9349, when the channels are identical. However, it is observed in FIG. 5 at ϵ=0.505 that I(W⁻⁻), I(W⁻⁺), I(W⁺⁻), and I(W⁺⁺) are, respectively, 0, 0, 0.9799, and 0.9998 when the channels are nonidentical. This implies a faster polarization again for nonidentical BECs than the identical BECs.

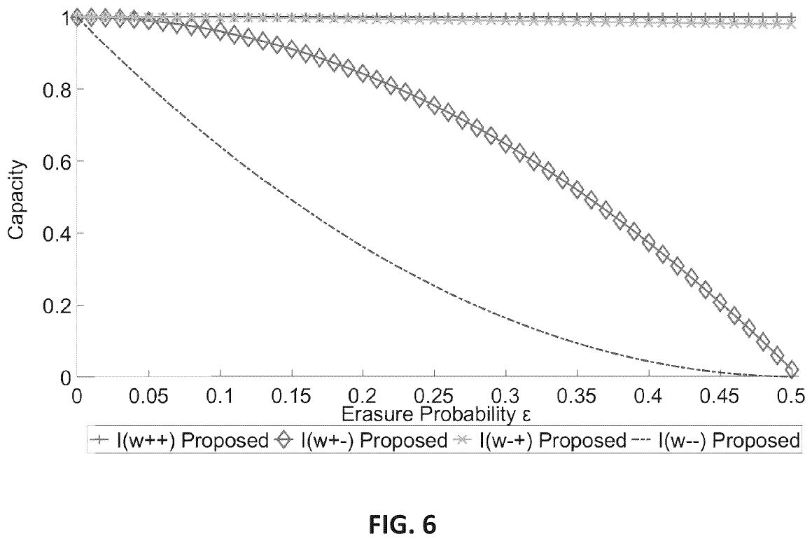

This N=4 case will be the first in which permutations of the channels can have a positive effect on the capacity changes of the polarized channels after permutations. FIGS. 4 and 5 display the identical and nonidentical case, respectively. The non-identical case in FIG. 5, is permuted as follows: ϵ₀=ϵ₁=0.99ϵ, ϵ₂=ϵ₃=0.01c. In FIG. 6 another possible permutation case is shown for N=4, which is permuted as follows: ϵ₀=ϵ₂=0.99ϵ, ϵ₁=ϵ₃=0.01ϵ. The I(W⁻⁺) and I(W⁺⁻) shown in FIG. 5 are swapped in FIG. 6. Note additionally, that the case in which ϵ₂=ϵ₃=0.99ϵ, ϵ₀=ϵ₁=0.01ϵ, is equivalent to what is shown in FIG. 5 due to the symmetry in (14), and that ϵ₁=ϵ₃=0.99ϵ, ϵ₀=ϵ₂=0.01ϵ, is equivalent to what is shown in FIG. 6. Thus there are only two possible effective permutations for the N=4 case. This illustrates the channel pairing that was discussed in (48). The pairs for the N=4 case from (14) is as follows: ϵ₀ with ϵ₂, and ϵ₁ with ϵ₃. It should be noted that capacity of the +− and −+ channels are the only channels affected by permutations. As can be observed by (14), the terminal channels, i.e., (++) and (−−) are perfectly symmetric and are not affected by permutations of any sort. In FIGS. 5 and 6 it can be observed that the polarized channel capacity perfectly swaps between the (+−) and (−+) channel depending on the pairing of the channels. This means that the reliability sequence is different depending on the permutation. The faster polarization of the non-identical vs the identical case should also be noted.

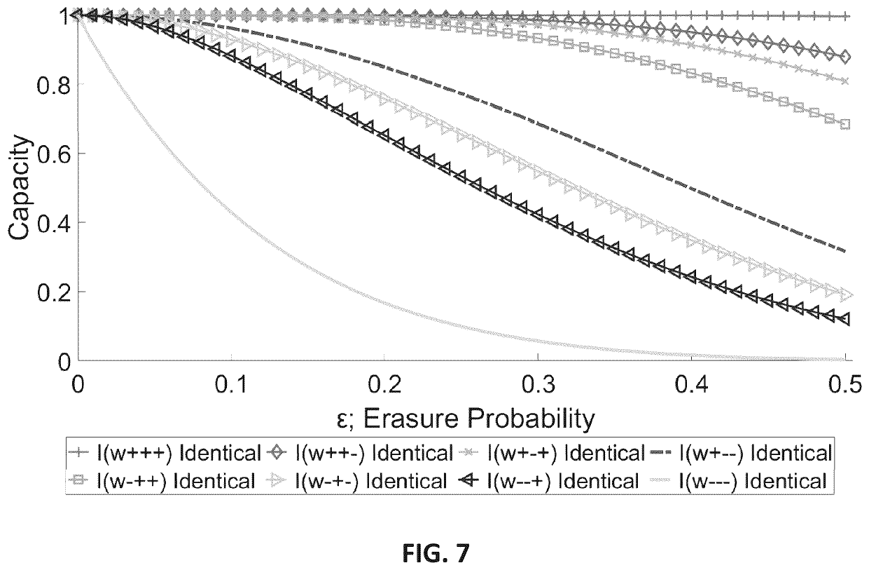

Next is examining the N=8 case. FIG. 7 shows eight polarized channel capacities I(W^{s}^{₀}^{s}^{₁}^{s}^{₂}) for the N=8 identical channels. It is observed in FIG. 7 at ϵ=0.505 that I(W⁻⁻⁻), I(W⁻⁻⁺), I(W⁻⁺⁻), I(W⁻⁺⁺), I(W⁺⁻⁻), I(W⁺⁻⁺), I(W⁺⁺⁻), and I(W⁺⁺⁺) are, respectively, 0.0036, 0.1165, 0.1849, 0.6751, 0.3081, 0.8019, 0.8741, and 0.9957 when the channels are identical. Also, it is observed that I⁻⁺⁺≥I⁺⁻⁻.

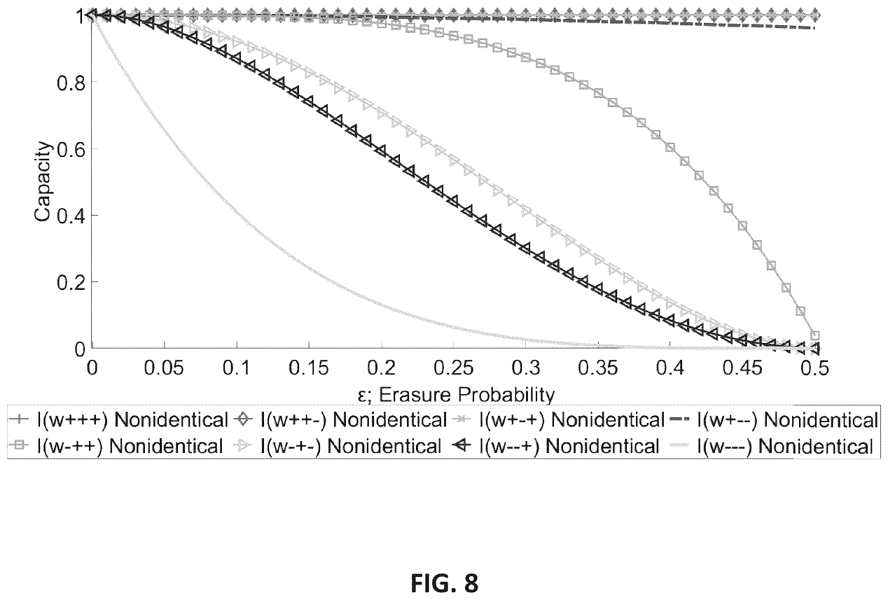

FIG. 8 shows eight polarized channel capacities I(W^{s}^{₀}^{s}^{₁}^{s}^{₂}) for the N=8 nonidentical channels. It is observed in FIG. 8 at ϵ=0.505 that I(W⁻⁻⁻), I(W⁻⁻⁺), I(W⁻⁺⁻), I(W⁻⁺⁺), I(W⁺⁻⁻), I(W⁺⁻⁺), I(W⁺⁺⁻), and I(W⁺⁺⁺) are, respectively, 0, 0, 0, 0.9799, 0, 0.9898, 0.9899, and 1 when the channels are nonidentical. Also, it is observed that I⁻⁺⁺≥I⁺⁻⁻. The polarization shown in FIG. 8 for the nonidentical BEC channels is much faster than that shown in FIG. 7 for the identical BEC channels.

The reliability sequence for the N=8 case shifts depending mostly on pairing of the channels, i.e., in general how ϵ₁ and ϵ_{1+N/2} are paired together. This symmetry gets increasingly complex as the N value increases. After iteration through every possible permutation it was found that the optimal permutation strategy is to assign a half of the BEC channels to the coded bit transmissions from the lowest erasure probability in a simple increasing sorting order, and the other half of the coded bits to assign continuously for the rest of the BEC channels in increasing order too. That is, ϵ₀=ϵ₁=ϵ₂=ϵ₃=0.01ϵ and ϵ₄=ϵ₅=ϵ₆=ϵ₇=0.99ϵ.

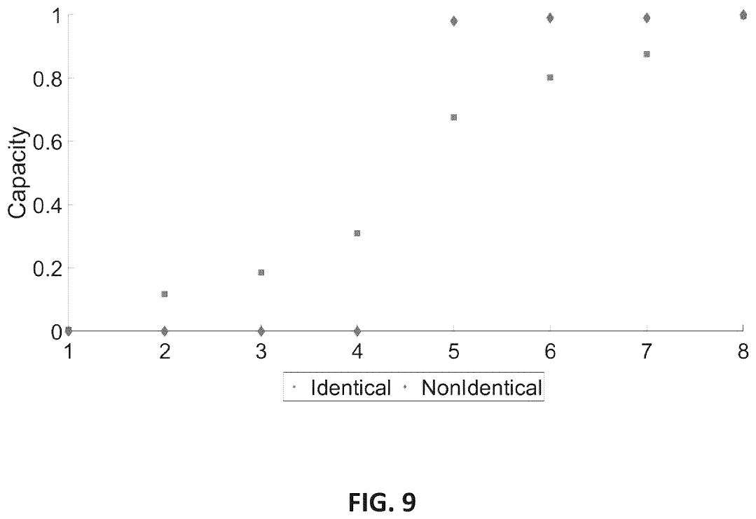

FIG. 9 shows the channel capacity of N=8 versus sorted bit channel index for identical W_{BEC}(ϵ) with squares and nonidentical W_{BEC}(ϵᵢ), i=0, 1 with rhombi at ϵ=0.509. It is observed again in FIG. 9 that the nonidentical channels with permutation show faster polarization than the identical channels.

These observations are not surprising because the nonidentical channels are already more polarized at the starting point than the identical ones. Methods of the present disclosure exploit this fact, e.g., permute the OFDM subcarrier channels with the available SINR report, and transmit the coded bits via more efficiently permuted OFDM subcarrier channel assignments. This may be considered with respect to permuting data to be transmitted through the OFDM subcarrier channels (e.g., permuting a plurality of data). A plurality of data (e.g., free bits and frozen bits) is first selected for transmission and then permuted based on the reliability sequence. As described throughout the present disclosure, this reliability sequence may be determined on the basis of the OFDM subcarriers' respective SINRs (e.g., as determined at user equipment). Positions deemed to be more reliable (e.g., those transmitted via high-reliability channels) are assigned to carry free bits, while less reliable positions (e.g., those transmitted via low-reliability channels) are reserved for frozen bits, which are set to known values and used to facilitate error correction. On the other hand, the existing 5G polar coded bits are transmitted via arbitrarily assigned OFDM subcarrier channels, which can show poor BER performance.

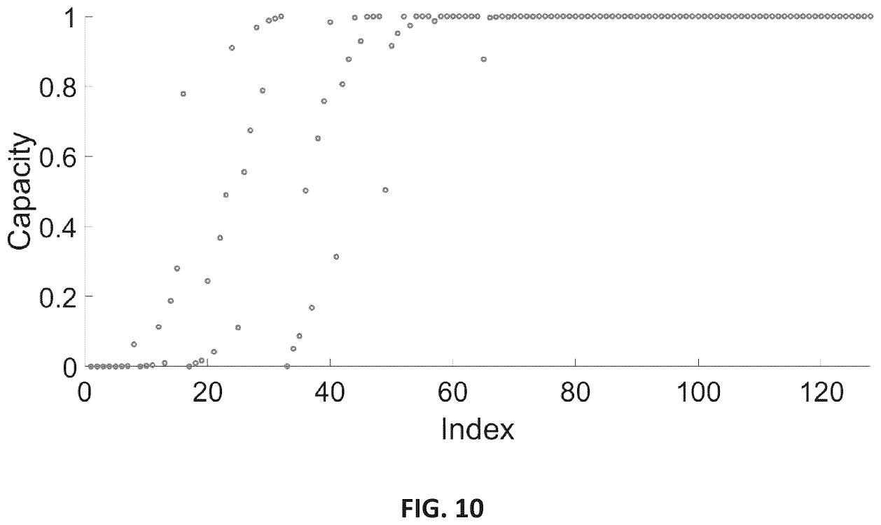

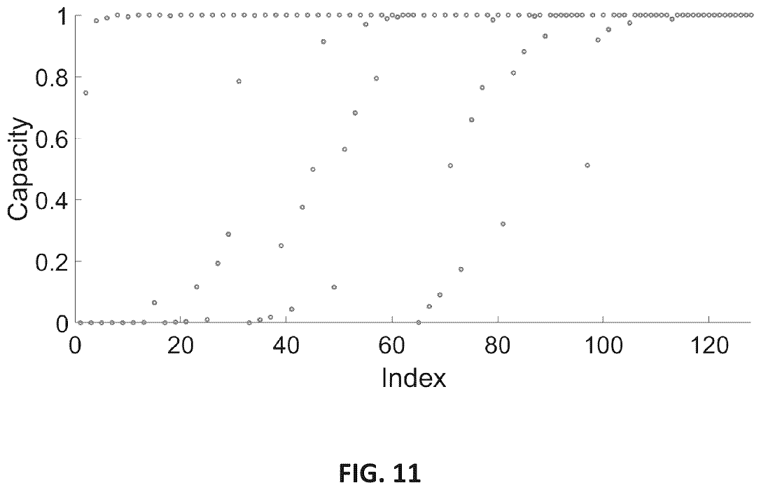

The high N case is much more complicated, due to the symmetry for some pair (ϵᵢ, ϵⱼ) and the asymmetry for some other pair (ϵₖ, ϵₗ) in (14), optimization is very difficult to determine even for our narrowed requirements. However, due to the symmetry of all the negatively and positively polarized channels, i.e., (s₀, . . . , sₗ₋₁)=(−, . . . , −) and (+, . . . , +) in (14), the previous sub-optimization strategy can be applied: For N=128, select a good channel set for 1 through 64 coded bits and a bad channel set for 65 through 128 coded bits. This was found to create a simplistic capacity distribution for a half rate code in FIG. 10. On the other hand, if a good and a bad channel is selected alternatively for 1 through 128 coded bit transmissions, then this strategy becomes a poor polarized capacity distribution as shown in FIG. 11. These observations also suggest a new reliability pattern under permutation. This reliability sequence will be discussed in greater detail below.

### B. Ber and Optimization Under Non-Identical

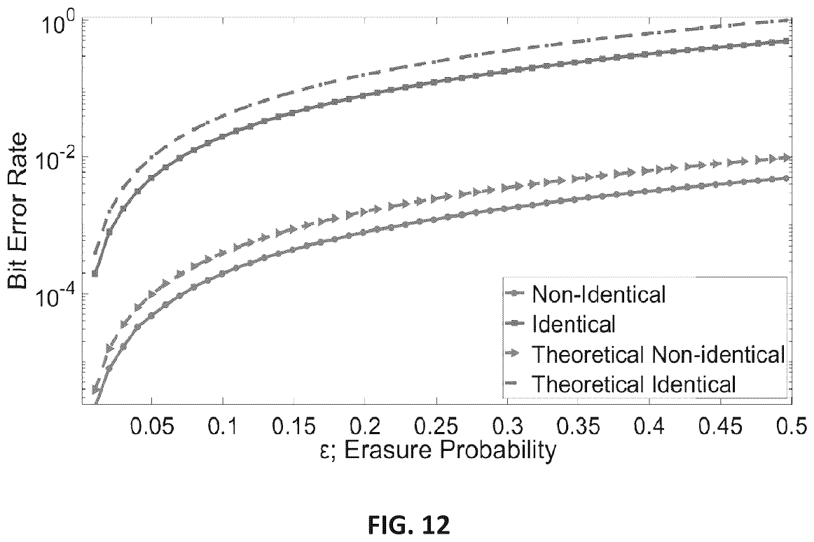

FIG. 12 shows the BER versus the erasure probability c for N=2 polar codes under the identical BEC channels of erasure probability c and the nonidentical BEC channels of erasure probability ϵ₀=2×0.99ϵ and ϵ₁=2×0.01ϵ. For the proposed N=2 polar code, the polar coded bits X₀ and X₁, where U₀ is frozen and U₁ is free, are transmitted via the worse channel of the BEC ϵ₀ and the better BEC of ϵ₁ corresponding to the free bit, respectively. For the conventional N=2 polar code, the polar coded bits X₀ and X₁ are carelessly transmitted via either the worse BEC of ϵ₀ or the better BEC of ϵ₁. Both the proposed and the conventional polar codes show the same BERs under nonidentical BECs when N=2. This is because the BER in (30) is ϵ₀ϵ₁, which is a symmetric function of ϵ₀ and ϵ₁, and hence ϵ₀ and ϵ₁ can be swapped without changing the BER or capacity order.

FIG. 12 shows also the theoretical BER approximations (not true ones) which are equal to ϵ² for identical channels and ϵ₀ϵ₁ for nonidentical channels. It is observed that the theoretical BER for the nonidentical channels is 2×0.99×2×0.01=0.0396 times smaller than the BER for the identical channels. It is also observed that the theoretical BER approximations are slightly higher than the simulation BERs.

Note that typically simulation shows higher BERs than theoretical ones. In the present disclosure, an LLR approximation has been used in (25), (32), (33), and (34), and hence the simulation can show lower BERs.

The symmetry in polarized capacity and BER holds only for N=2 case. When N>4, the symmetry does not hold, and the proposed polar code can show much better performance than the conventional ones. FIG. 13 shows the N=4 BER versus the erasure probability c for both the proposed and the conventional worst case polar codes under the nonidentical BEC channels of erasure probability ϵ₀=ϵ₁=0.99ϵ and ϵ₂=ϵ₃=0.01ϵ. The optimization was the result of the capacity analysis previously discussed. The proposed polar code BER shows about two decades smaller BER than the conventional worst case polar code BERs for all E. This is because the proposed polar code as shown in FIG. 2 transmits the coded bits X₁ and X₂ via W(ϵ₂) and W(ϵ₁) with a simple swapping, respectively. However, the conventional worst case polar code as shown in FIG. 1 transmits the coded bits X₁ and X₂ via W(ϵ₁) and W(ϵ₂), respectively, without subcarrier permutation. A simple permutation between W(ϵ₁) and W(ϵ₂) can yield about two decades BER improvement over the conventional worst case polar code for a given nonidentical vector channel of ϵ₀=ϵ₁=0.99ϵ and ϵ₂=ϵ₃=0.01ϵ.

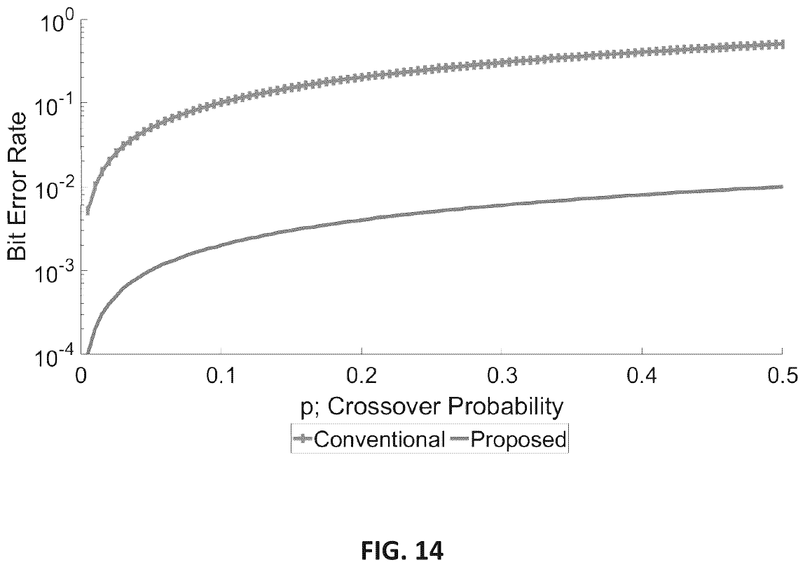

FIG. 14 shows the BER versus the crossover probability p for both the proposed and conventional worst case N=4 polar codes under the nonidentical BSC channels of crossover probability of p₀=p₁=0.99p and p₂=p₃=0.01p. The optimization was the result of the capacity analysis previously discussed. The proposed polar code BER shows a more than two decades smaller BER than the conventional polar code BERs. The same justifications used for N=4 BER results shown in FIG. 14 can be applied.

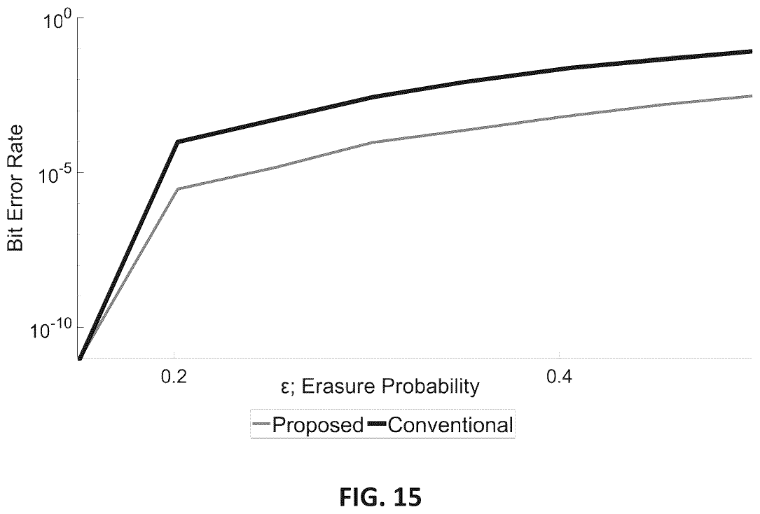

FIG. 15 shows the BER versus the erasure probability c for the N=128 BEC vector channel case with the proposed scheme and the conventional one. The sub-optimization for the high N case discussed above and the new reliability sequence discussion were used. The BER in black is for the conventional polar code with randomly permuted channel and the reliability sequence as the original polar code bit transmission and the BER in grey is for the polar code bit transmission with the proposed permutation and reliability sequence obtained from (14) when ϵ₀= . . . =ϵ₆₃=0.99ϵ and ϵ₆₄= . . . =ϵ₁₂₇=0.01ϵ. Significant BER improvement over the conventional scheme can be achieved using embodiments of the present disclosure. For example, more than two decades BER improvement can be observed in FIG. 15

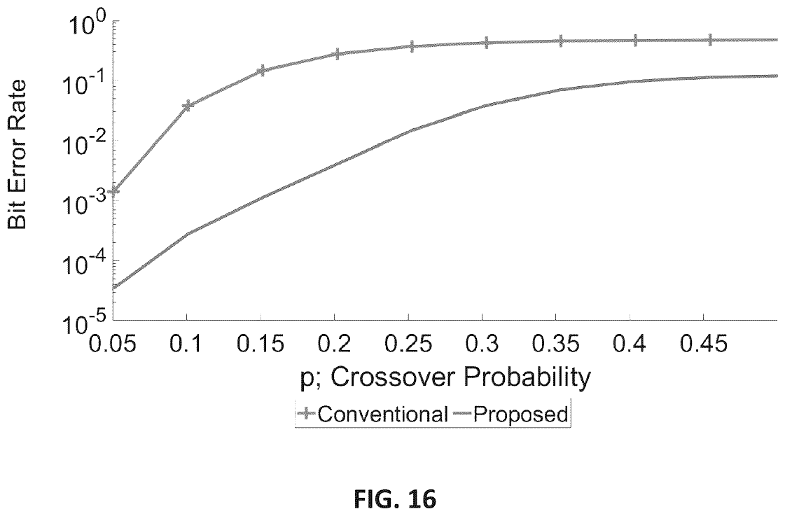

FIG. 16 shows the BER versus the crossover probability p corresponding to the BSC N=128 vector channel case using the same sub-optimization strategy employed for the BEC. Again, significant BER improvement can be achieved with the proposed OFDM subcarrier permutation. A BER improvement between more than half a decade and two decades can be observed in FIG. 16.

### C. Implementation Algorithm

Algorithm 1 in the table below summarizes a permutation and reliability sequence search according to an embodiment of the present disclosure.

Firstly, the objective is to search a permutation pattern so that polarization capacity is increased. The sorted channels case was examined, which is a simple permutation and can sub-optimally accomplish the objective. Investigating different permutations to meet the objective for a specific scenario may be necessary and is made possible by (14).

Secondly, reliability sequences can be created using (14). Algorithm 1 is created for the scenario in which a brute force computing (14) for all possible permutations is not feasible under the time and power constraints. Algorithm 1 finds the average SINR of the best half and worst half of the channels, and then outputs a polarization value. Using this value, a reliability sequence can be estimated using the average values of the best and worst half of the SINR. Using (14) a variety of reliability sequences can be determined based on the amount of polarization between channels. Algorithm 1 is an example algorithm used for the N=128 case investigated in the present disclosure. This algorithm is constructed for the case that the encoder doesn't have the processing power to fully calculate the capacities of the channel creating a new reliability sequence each time.

According to embodiments of the present disclosure, generating a reliability sequence using the SINRs of each of the OFDM subcarriers involves ranking the subcarriers according to their respective SINRs, designating high-reliability channels and low-reliability channels, calculating a polarization value using the average best SINR and the average worst SINR, and estimating an optimal reliability sequence based on the polarization value. In essence, because the SINRs are an indication of channel quality, they may be used to predict/estimate the relative BERs of each OFDM subcarrier channel. That is, OFDM subcarrier channels having higher SINRs (reduced noise) will generally have lower BERs and are thus more reliable, and OFDM subcarrier channels having lower SINRs (increased noise) will generally have higher BERs and are thus less reliable. By generating a reliability sequence- and permuting the OFDM subcarrier channels and/or the data passed therethrough-according to SINR measurements which already exist (e.g., are already measured by many devices), empirical data is used to improve communication quality without added complexity.

Algorithm 1 N = 128 optimization

```
Inputs:
  S ∈ SINR_{1...N} [symbol]
Sorted from highest to lowest
n ← N
j ← 1
H ← 0
L ← 0
while j ≠ n/2 do
  L ← 2L/n + S_{n/2+1+j}
  H ← 2H/n + Sⱼ
  j ← j + 1
end while
P ← L/H [symbol]   Use value to select reliability sequence using
(14)
```

The results shown in FIGS. 12 to 14 verify for codeword length N=2, 4 cases that the polar coding system under a nonidentical channel environment shows a faster polarization for a given i-fold Kronecker matrix or a given codeword length N=21. Using the general capacity equations in (14) and (15), the polar code analysis under a nonidentical channel environment can be extended to a polar code of a larger codeword length under BECs similar to Theorem 2.

Furthermore, the BER results verify that the proposed polar code can show a significantly lower BER than the existing polar codes for N=4 codeword length depending on the nonidentical BEC erasure probability or BSC crossover probability.

Mathematical proofs of capacity convergence I_{W}_{^{s}}_{0,s}_{¹}_{, . . . s}_{^{l-2}}_{,s}_{^{l-1}}(ϵ₀, . . . , ϵ_{N-1}) as N increases and the BER performance superiority of the proposed polar code over the conventional ones for an arbitrary N are left for future work.

### III. Conclusion

For the existing and 5G polar coded systems, there has been not much discretion in the OFDM subcarrier carrier assignments for the coded bit transmissions. In practice, the 5G OFDM subcarriers can have nonidentical transition probability matrices because the SINR varies depending on the OFDM subcarrier index. In the present disclosure, it was proposed to simply permute the OFDM subcarrier assignment and transmit the coded bits. Then, a significant BER improvement, e.g., more than two decades depending on the nonidentical probabilities, was observed via both simulation and theoretical analysis. The proposed polar coded system is implementable and does not require additional complexity because the same polar code Kronecker matrix is used and 5G SINR report is available at both the UE and gNodeB. Only simple permutation among the OFDM subcarrier assignment is required. Furthermore, in the present disclosure, the equivalent erasure probability and the corresponding mutual information, i.e., polarized channel capacity for a BEC and a BSC vector channel of length N=21 were derived when the component BEC channel is nonidentical. Finally, it was shown theoretically that a nonidentical vector channel has a higher positively polarization and a lower negatively polarization than an identical vector channel.

The base station node and user equipment may include one or more processors (e.g., a station processor, a user equipment processor) coupled to non-transitory computer-readable media storing instructions for implementing the techniques described herein. The one or more station processors in the base station node may execute instructions to perform operations such as generating reliability sequences, permuting data based on the reliability sequences, and transmitting the permuted data via OFDM subcarriers. Similarly, the one or more user equipment processors may execute instructions to perform operations such as determining SINRs for OFDM subcarriers, generating reliability sequences, and transmitting the reliability sequences to the base station node.

The non-transitory computer-readable media may include memory devices such as RAM, ROM, solid state drives, or other storage media. The stored instructions, when executed by the respective processors, configure the base station node and user equipment to carry out their respective functions. This may include implementing channel permutation, reliability sequence generation, and optimized bit transmission.

The processors and associated computer-readable media provide the capability to implement techniques of the present disclosure in a flexible and programmable manner. This allows for adaptation of the coding scheme to different channel conditions and network configurations through software updates without requiring hardware modifications. The processor-based implementation also enables real-time optimization of the coding parameters based on current channel measurements and feedback.

While the systems and methods above have been described and disclosed in certain terms and have disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. A method of communication between a first communication device and a second communication device, the method comprising:
transmitting, from the first communication device to the second communication device, a first plurality of data via a signal comprising a plurality of orthogonal-frequency-division-multiplexing (OFDM) subcarriers;
determining a signal-to-interference-plus-noise-ratio (SINR) for each of the plurality of OFDM subcarriers;
generating a reliability sequence using, at least in part, the SINRs of each of the OFDM subcarriers;
permuting a second plurality of data based on the reliability sequence; and
transmitting, from the first communication device to the second communication device, the second plurality of data.

2. The method set forth in claim 1, wherein generating the reliability sequence comprises ranking, in ascending order, the plurality of OFDM subcarriers according to their respective SINRs.

3. The method set forth in claim 2, wherein generating the reliability sequence further comprises designating at least a portion of the plurality of OFDM subcarriers as high-reliability channels and at least a portion of the plurality of OFDM subcarriers as low-reliability channels.

4. The method set forth in claim 3, wherein designating at least a portion of the plurality of OFDM subcarriers as high-reliability channels comprises selecting an upper half of the OFDM subcarriers of the sorted reliability sequence.

5. The method set forth in claim 4, wherein designating at least a portion of the plurality of OFDM subcarriers as low-reliability channels comprises selecting a lower half of the OFDM subcarriers of the sorted reliability sequence.

6. The method set forth in claim 5, wherein generating the reliability sequence further comprises determining an average best SINR from the high-reliability channels, determining an average worst SINR from the low-reliability channels, and calculating a polarization value using the average best SINR and the average worst SINR.

7. The method set forth in claim 6, wherein generating the reliability sequence further comprises estimating an optimal reliability sequence based on the polarization value.

8. The method set forth in claim 7, wherein the first communication device is communicatively coupled to a base station node of a cellular network.

9. The method set forth in claim 8, wherein the second communication device is communicatively coupled to user equipment.

10. The method set forth in claim 9, wherein determining the SINRs for each of the plurality of OFDM subcarriers is performed by the user equipment.

11. The method set forth in claim 10, wherein generating the reliability sequence is performed by the user equipment and transmitted to the base station node.

12. The method set forth in claim 10, wherein generating the reliability sequence is performed by the base station node.

13. The method set forth in claim 12, wherein the base station node generates the reliability sequence at a medium access control layer thereof.

14. The method set forth in claim 8, wherein the user equipment comprises at least one wireless cellular device, and wherein the cellular network is a fifth-generation cellular network.

15. The method set forth in claim 3, wherein the second plurality of data comprises free bits and frozen bits, and wherein permuting said second plurality of data comprises arranging the free bits and frozen bits according to the reliability sequence such that, when transmitted from the first communication device to the second communication device, the free bits are communicated through the high-reliability channels and the frozen bits are communicated through the low-reliability channels.

16. A cellular network configured for high reliability wireless data transmission, the cellular network comprising:
a base station node and at least one user equipment configured to wirelessly communicate with one another;
one or more station processors operably coupled to the base station node;
one or more non-transitory computer-readable media coupled to the one or more station processors, the one or more non-transitory computer-readable media storing instructions which, when executed by the one or more station processors, configure the base station node to perform operations comprising:
transmitting, from the base station node to the at least one user equipment, a first plurality of data via a signal comprising a plurality of orthogonal-frequency-division-multiplexing (OFDM) subcarriers;
in response to receiving, from the at least one user equipment, a signal-to-interference-plus-noise-ratio (SINR) associated with each of the plurality of OFDM subcarriers:
generating a reliability sequence using, at least in part, the SINRs received from the at least one user equipment;
permuting a second plurality of data based on the reliability sequence; and
transmitting the second plurality of data from the base station node to the at least one user equipment via the plurality of OFDM subcarriers.

17. The cellular network set forth in claim 16, wherein generating the reliability sequence comprises ranking, in ascending order, the plurality of OFDM subcarriers according to their respective SINRs, determining an average best SINR from an upper half of the OFDM subcarriers in the reliability sequence, determining an average worst SINR from a lower half of the OFDM subcarriers in the reliability sequence, and calculating a polarization value using the average best SINR and the average worst SINR.

18. The cellular network set forth in claim 17, wherein generating the reliability sequence further comprises estimating an optimal reliability sequence based on the polarization value.

19. The cellular network set forth in claim 16, wherein the cellular network is a fifth generation cellular network.

20. A cellular network configured for high reliability wireless data transmission, the cellular network comprising:
a base station node and at least one user equipment configured to wirelessly communicate with one another;
one or more user equipment processors operably coupled to the at least one user equipment;
one or more non-transitory computer-readable media coupled to the one or more user equipment processors, the one or more non-transitory computer-readable media storing instructions which, when executed by the one or more user equipment processors, configure the at least one user equipment to perform operations comprising:
determining a signal-to-interference-plus-noise-ratio (SINR) for each of a plurality of orthogonal-frequency-division-multiplexing (OFDM) subcarriers transmitted to the at least one user equipment by the base station node;
generating a reliability sequence using, at least in part, the determined SINRs of each of the plurality of OFDM subcarriers; and
transmitting the reliability sequence to the base station node.
